(19) United States
(12) Patent Application Publication
(10) Pub. No.: US 2020/0168857 A1
(43) Pub. Date: May 28, 2020

(54) BATTERY PACKAGING MATERIAL, METHOD FOR PRODUCING THE SAME, AND BATTERY

(71) Applicant: DAI NIPPON PRINTING CO., LTD., Tokyo (JP)

(72) Inventors: Kaoru TSUMORI, Tokyo (JP); Takanori YAMASHITA, Tokyo (JP); Rikiya YAMASHITA, Tokyo (JP)

(73) Assignee: DAI NIPPON PRINTING CO., LTD., Tokyo (JP)

(21) Appl. No.: 16/632,250

(22) PCT Filed: Jul. 19, 2018
(86) PCT No.: PCT/JP2018/027188

§ 371 Date: Jan. 17, 2020

(30) Foreign Application Priority Data
Jul. 19, 2017 (JP) 2017-139815

(51) Int. Cl. H01M 2/02; B32B 27/08; B32B 27/36; H01M 2/08; B32B 7/12; B32B 27/32

(52) U.S. Cl. CPC H01M 2/0287; B32B 27/08; B32B 27/32; H01M 2/08; B32B 7/12; B32B 27/365

(57) ABSTRACT

A battery packaging material having excellent long-term adhesion of a barrier layer having an acid resistance film. The battery packaging material includes a laminate including at least a base material layer, a barrier layer, and a heat-sealable resin layer in this order, wherein the battery packaging material includes an acid resistance film on at least one surface of the barrier layer, and when the acid resistance film is analyzed using time-of-flight secondary ion mass spectrometry, a P_{PO3/CrPO4} ratio, which is the ratio of peak intensity P_{PO3} derived from PO₃⁻ to peak intensity P_{CrPO4} derived from CrPO₄⁻, falls within a range of 6 to 120.

### TECHNICAL FIELD

The present invention relates to a battery packaging material, a method for producing the battery packaging material, and a battery.

### BACKGROUND ART

Various types of batteries have been heretofore developed. In these batteries, a battery element including an electrode, an electrolyte, and the like need to be sealed with a packaging material or the like. As battery packaging materials, metallic packaging materials have been widely used.

In recent years, along with improvements in the performance of electric cars, hybrid electric cars, personal computers, cameras, mobile phones, and the like, batteries with diverse shapes have been required. Batteries have also been required to be thinner and lighter weight, for example. However, the widely used metallic packaging materials have difficulty in keeping up with the diversification of battery shapes. Moreover, because the packaging materials are made of metal, they are limited in terms of weight reduction.

Thus, a film-shaped laminate in which a base material layer/a barrier layer/a heat-sealable resin layer are laminated in this order has been proposed as a battery packaging material that can be readily processed into diverse shapes, and can achieve a reduction in thickness and weight (see, for example, Patent Literature 1).

In such a film-shaped battery packaging material, typically, a concave portion is formed by molding, a battery element including an electrode, an electrolytic solution, and the like is disposed in the space formed by the concave portion, and the heat-sealable resin layer is heat-sealed with itself. As a result, a battery in which the battery element is housed inside the battery packaging material is obtained.

### CITATION LIST

### Patent Literature

Patent Literature 1: JP 2008-287971 A

### SUMMARY OF INVENTION

### Technical Problem

When moisture enters into a battery, it may react with the electrolyte or the like to produce an acid substance. For example, an electrolytic solution used in a lithium ion battery or the like contains a fluorine compound (such as LiPF₆ or LiBF₄) as the electrolyte. It is known that when the fluorine compound reacts with water, it produces hydrogen fluoride.

The barrier layer of the battery packaging material formed by the film-shaped laminate is usually composed of metal foil or the like, and has the drawback of being easily corroded when it is contacted with an acid. For improving the acid resistance of this battery packaging material, a technique is known that uses a barrier layer having a surface on which an acid resistance film is formed by a chemical conversion treatment.

Various methods are known as the chemical conversion treatment for forming an acid resistance film, including a chromate treatment using a chromium compound, such as chromium oxide, and a phosphoric acid treatment using a phosphoric acid compound.

However, as a result of research conducted by the inventors of the present invention, it was revealed that a conventional barrier layer having an acid resistance film is unsatisfactory in terms of long-term adhesion to a layer adjacent to the side having the acid resistance film (that is, adhesion at the interface between the acid resistance film and the layer in contact with the acid resistance film). More specifically, the adhesion may become unsatisfactory when the electrolytic solution adheres to the battery packaging material.

Among batteries, particularly batteries used in vehicles such as electric cars and hybrid electric cars are large and used over a long period. In these batteries, therefore, the adhesion is required to be retained over a long period. As used herein, “long period” refers to the period that is approximately the lifetime of a battery required in a vehicle such as an electric car or a hybrid electric car, for example, about 6 to 20 years, and even about 15 to 20 years.

Under such circumstances, it is a main object of the present invention to provide a battery packaging material having excellent long-term adhesion of a barrier layer having an acid resistance film. It is another object of the present invention to provide a method for producing the battery packaging material and a battery comprising the battery packaging material.

### Solution to Problem

The inventors of the present invention conducted extensive research to solve the aforementioned problem. As a result, they found that a battery packaging material comprising a laminate comprising at least a base material layer, a barrier layer, and a heat-sealable resin layer in this order, wherein the battery packaging material comprises an acid resistance film on at least one surface of the barrier layer, and when the acid resistance film is analyzed using time-of-flight secondary ion mass spectrometry, a P_{PO3/CrPO4} ratio, which is the ratio of peak intensity P_{PO3} derived from PO₃⁻ to peak intensity P_{CrPO4} derived from CrPO₄⁻, falls within a range of 6 to 120, has excellent long-term adhesion when an electrolytic solution adheres to the battery packaging material, even though it comprises the acid resistance film on the surface of the barrier layer.

The present inventors also found that a battery packaging material comprising a laminate comprising at least a base material layer, a barrier layer, and a heat-sealable resin layer in this order, wherein the battery packaging material comprises an acid resistance film on at least one surface of the barrier layer, and when the acid resistance film is analyzed using time-of-flight secondary ion mass spectrometry, a P_{PO2/CrPO4} ratio, which is the ratio of peak intensity P_{PO2} derived from PO₂⁻ to peak intensity P_{CrPO4} derived from CrPO₄⁻, falls within a range of 7 to 70, also has excellent long-term adhesion when an electrolytic solution adheres to the battery packaging material, even though it comprises the acid resistance film on the surface of the barrier layer.

In particular, the present inventors found that the barrier layer having the above-described acid resistance film can retain long-term adhesion, and the battery packaging material is particularly useful as, for example, a packaging material for a large battery used in a vehicle such as an electric car or a hybrid electric car.

The present invention was completed as a result of further research based on these findings.

In summary, the present invention provides embodiments of the invention as itemized below:

Item 1. A battery packaging material comprising:

a laminate comprising at least a base material layer, a barrier layer, and a heat-sealable resin layer in this order,

wherein the battery packaging material comprises an acid resistance film on at least one surface of the barrier layer, and

when the acid resistance film is analyzed using time-of-flight secondary ion mass spectrometry, a P_{PO3/CrPO4} ratio, which is the ratio of peak intensity P_{PO3} derived from PO₃⁻ to peak intensity P_{CrPO4} derived from CrPO₄⁻, falls within a range of 6 to 120.

Item 2. The battery packaging material according to item 1, wherein the battery packaging material comprises the acid resistance film on at least a surface of the barrier layer facing the heat-sealable resin layer.

Item 3. The battery packaging material according to item 2, wherein the acid resistance film and the heat-sealable resin layer are laminated with an adhesive layer interposed therebetween.

Item 4. The battery packaging material according to item 3, wherein a resin constituting the adhesive layer has a polyolefin backbone.

Item 5. The battery packaging material according to item 3 or 4, wherein the adhesive layer contains an acid-modified polyolefin.

Item 6. The battery packaging material according to any one of items 3 to 5, wherein when the adhesive layer is analyzed using infrared spectroscopy, a peak derived from maleic anhydride is detected.

Item 7. The battery packaging material according to item 6, wherein the acid-modified polyolefin in the adhesive layer is maleic anhydride-modified polypropylene, and

the heat-sealable resin layer contains polypropylene.

Item 8. The battery packaging material according to any one of items 3 to 7, wherein the adhesive layer is a cured product of a resin composition containing at least one selected from the group consisting of a compound having an isocyanate group, a compound having an oxazoline group, and a compound having an epoxy group.

Item 9. The battery packaging material according to any one of items 3 to 8, wherein the adhesive layer is a cured product of a resin composition containing a curing agent having at least one selected from the group consisting of an oxygen atom, a heterocyclic ring, a C═N bond, and a C—O—C bond.

Item 10. The battery packaging material according to any one of items 3 to 9, wherein the adhesive layer contains at least one selected from the group consisting of a urethane resin, an ester resin, and an epoxy resin.

Item 11. The battery packaging material according to any one of items 1 to 10, wherein the barrier layer is composed of aluminum foil.

Item 12. The battery packaging material according to any one of items 1 to 11, wherein a resin constituting the heat-sealable resin layer contains a polyolefin backbone.

Item 13. A method for producing a battery packaging material comprising the step of:

obtaining a laminate by laminating at least a base material layer, a barrier layer, and a heat-sealable resin layer in this order,

wherein when the barrier layer is laminated, the barrier layer comprises an acid resistance film on at least one surface thereof, and when the acid resistance film is analyzed using time-of-flight secondary ion mass spectrometry, a P_{PO3/CrPO4} ratio, which is the ratio of peak intensity P_{PO3} derived from PO₃⁻ to peak intensity P_{CrPO4} derived from CrPO₄⁻, falls within a range of 6 to 120.

Item 14. A battery comprising a battery element comprising at least a positive electrode, a negative electrode, and an electrolyte, the battery element being housed in a package formed of the battery packaging material according to any one of items 1 to 12.

Item 15. Use of a laminate comprising at least a base material layer, a barrier layer, and a heat-sealable resin layer in this order for a battery packaging material,

wherein the laminate comprises an acid resistance film on at least one surface of the barrier layer, and

when the acid resistance film is analyzed using time-of-flight secondary ion mass spectrometry, a P_{PO3/CrPO4} ratio, which is the ratio of peak intensity P_{PO3} derived from PO₃⁻ to peak intensity P_{CrPO4} derived from CrPO₄⁻, falls within a range of 6 to 120.

### Advantageous Effects of Invention

The present invention can provide a battery packaging material having excellent long-term adhesion of a barrier layer having an acid resistance film. The present invention can also provide a method for producing the battery packaging material and a battery comprising the battery packaging material.

### BRIEF DESCRIPTION OF DRAWINGS

FIG. 1 is a schematic diagram showing one example of a cross-sectional structure of a battery packaging material of the present invention.

FIG. 2 is a schematic diagram showing one example of a cross-sectional structure of a battery packaging material of the present invention.

FIG. 3 is a schematic diagram showing one example of a cross-sectional structure of a battery packaging material of the present invention.

FIG. 4 is a schematic diagram showing one example of a cross-sectional structure of a battery packaging material of the present invention.

FIG. 5 is a schematic diagram showing one example of a cross-sectional structure of a battery packaging material of the present invention.

### DESCRIPTION OF EMBODIMENTS

A battery packaging material according to a first embodiment of the present invention comprises a laminate comprising at least a base material layer, a barrier layer, and a heat-sealable resin layer in this order, wherein the battery packaging material comprises an acid resistance film on at least one surface of the barrier layer, and when the acid resistance film is analyzed using time-of-flight secondary ion mass spectrometry, a P_{PO3/CrPO4} ratio, which is the ratio of peak intensity P_{PO3} derived from PO₃⁻ to peak intensity P_{CrPO4} derived from CrPO₄⁻, falls within a range of 6 to 120.

A battery packaging material according to a second embodiment of the present invention comprises a laminate comprising at least a base material layer, a barrier layer, and a heat-sealable resin layer in this order, wherein the battery packaging material comprises an acid resistance film on at least one surface of the barrier layer, and when the acid resistance film is analyzed using time-of-flight secondary ion mass spectrometry, a P_{PO2/CrPO4} ratio, which is the ratio of peak intensity P_{PO3} derived from PO₂⁻ to peak intensity P_{CrPO4} derived from CrPO₄⁻, falls within a range of 7 to 70.

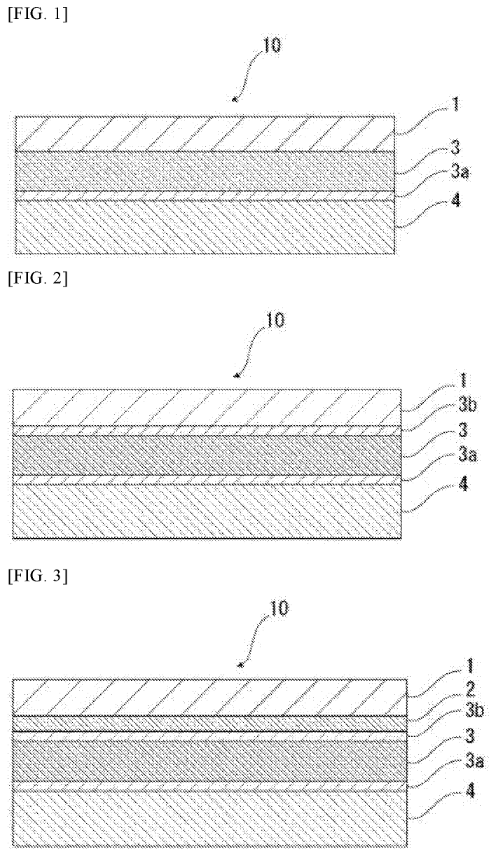

Hereinafter, referring to FIGS. 1 to 5, the battery packaging material of the present invention, a method for producing the battery packaging material, and a battery comprising the battery packaging material will be described in detail.

In the present specification, any numerical range indicated by “ . . . to . . . ” is intended to mean “ . . . or more” and “ . . . or less”. For example, the recitation “2 to 15 mm” is intended to mean 2 mm or more and 15 mm or less.

1. Laminated Structure of Battery Packaging Material

As shown in FIG. 1, for example, a battery packaging material of the present invention comprises a laminate having at least a base material layer 1, a barrier layer 3, and a heat-sealable resin layer 4 in this order. In the battery packaging material of the present invention, the base material layer 1 is an outermost layer, and the heat-sealable resin layer 4 is an innermost layer. That is, during the assembly of a battery, the heat-sealable resin layer 4 positioned on the periphery of a battery element is heat-sealed with itself to hermetically seal the battery element, such that the battery element is encapsulated.

The battery packaging material comprises an acid resistance film on at least one surface of the barrier layer 3. The acid resistance film contains chromium. FIG. 1 shows a schematic diagram of a case where the battery packaging material of the present invention comprises an acid resistance film 3a on a surface of the barrier layer 3 facing the heat-sealable resin layer 4. FIG. 2 shows a schematic diagram of a case where the battery packaging material of the present invention comprises acid resistance films 3a and 3b on both surfaces of the barrier layer 3. As described below, the battery packaging material of the present invention may comprise the acid resistance film 3a on only the surface of the barrier layer 3 facing the heat-sealable resin layer 4, or may comprise the acid resistance film 3b on only a surface of the barrier layer 3 facing the base material layer 1, or may comprise the acid resistance films 3a and 3b on both surfaces of the barrier layer 3.

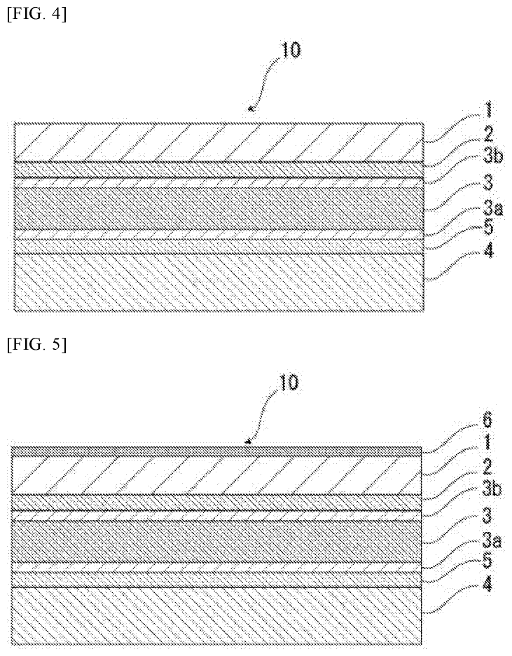

As shown in FIG. 3, the battery packaging material of the present invention may optionally comprise an adhesive agent layer 2 between the base material layer 1 and the barrier layer 3, for the purpose of improving the adhesiveness between these layers. Moreover, as shown in FIG. 4, the battery packaging material of the present invention may also optionally comprise an adhesive layer 5 between the barrier layer 3 and the heat-sealable resin layer 4, for the purpose of improving the adhesiveness between these layers. Furthermore, as shown in FIG. 5, the battery packaging material of the present invention may also optionally comprise a surface coating layer 6 on a surface of the base material layer 1 opposite to the barrier layer 3, for the purpose of enhancing the designability, electrolytic solution resistance, scratch resistance, and moldability, for example.

While the thickness of the laminate constituting the battery packaging material 10 of the present invention is not particularly limited, it is, for example, about 180 μm or less, preferably about 150 μm or less, more preferably about 60 to 180 μm, and still more preferably about 60 to 150 μm, from the viewpoint of obtaining a battery packaging material having excellent moldability, while reducing the thickness of the battery packaging material and increasing the energy density of the battery.

In the battery packaging material, MD and TD in the production process can be usually identified in the below-described barrier layer 3. For example, when the barrier layer 3 is composed of aluminum foil, linear streaks, which are so-called rolling marks, are formed on the surface of the aluminum foil in the rolling direction (RD) of the aluminum foil. Because the rolling marks extend along the rolling direction, the rolling direction of the aluminum foil can be grasped by observing the surface of the aluminum foil. Moreover, because MD of the laminate usually corresponds to RD of the aluminum foil in the production process of the laminate, MD of the laminate can be identified by identifying the rolling direction (RD) of the aluminum foil. Moreover, because TD of the laminate is perpendicular to MD of the laminate, TD of the laminate can also be identified.

2. Layers that Form Battery Packaging Material

[Base Material Layer 1]

In the battery packaging material of the present invention, the base material layer 1 is positioned as an outermost layer. The material that forms the base material layer 1 is not particularly limited as long as it has insulation properties. Examples of the material that forms the base material layer 1 include resin films of polyester resins, polyamide resins, epoxy resins, acrylic resins, fluororesins, polyurethane resins, silicone resins, phenol resins, polycarbonate resins, and mixtures or copolymers thereof, for example. Among the above, polyester resins and polyamide resins are preferred, and biaxially stretched polyester resins and biaxially stretched polyamide resins are more preferred. Specific examples of polyester resins include polyethylene terephthalate, polybutylene terephthalate, polyethylene naphthalate, polybutylene naphthalate, and copolyesters. Specific examples of polyamide resins include nylon 6, nylon 66, copolymers of nylon 6 and nylon 66, nylon 6,10, and polyamide MXD6 (polymethaxylylene adipamide).

While the base material layer 1 may be formed of a single layer of a resin film, it may be formed of two or more layers of resin films, in order to improve the pinhole resistance or insulation properties. Specific examples include a multilayer structure in which a polyester film and a nylon film are laminated, a multilayer structure in which a plurality of layers of nylon films are laminated, and a multilayer structure in which a plurality of layers of polyester films are laminated. When the base material layer 1 has a multilayer structure, it is preferably composed of a laminate of a biaxially stretched nylon film and a biaxially stretched polyester film, a laminate of a plurality of layers of biaxially stretched nylon films, or a laminate of a plurality of layers of biaxially stretched polyester films. For example, when the base material layer 1 is formed of two layers of resin films, it preferably has a structure in which a polyester resin and a polyester resin are laminated, a structure in which a polyamide resin and a polyamide resin are laminated, or a structure in which a polyester resin and a polyamide resin are laminated, and more preferably has a structure in which polyethylene terephthalate and polyethylene terephthalate are laminated, a structure in which nylon and nylon are laminated, or a structure in which polyethylene terephthalate and nylon are laminated. Because a polyester resin is unlikely to discolor when, for example, an electrolytic solution adheres to the surface, the laminated structure of the base material layer 1 is preferably formed such that the polyester resin is positioned as an outermost layer. When the base material layer 1 has a multilayer structure, the thickness of each of the layers is preferably about 2 to 25 μm.

When the base material layer 1 is formed of multiple layers of resin films, the two or more resin films may be laminated with an adhesive component such as an adhesive or an adhesive resin interposed therebetween. The type, the amount, and the like of the adhesive component to be used are the same as described below for the adhesive agent layer 2. The method for laminating the two or more layers of resin films is not particularly limited, and a known method can be adopted, such as, for example, a dry lamination method or a sandwich lamination method, preferably the dry lamination method. When the layers are laminated using the dry lamination method, a urethane-based adhesive is preferably used as an adhesive layer. In this case, the thickness of the adhesive layer is about 2 to 5 μm, for example.

In the present invention, from the viewpoint of improving the moldability of the battery packaging material, a lubricant is preferably adhered to the surface of the base material layer 1. While the lubricant is not particularly limited, it is preferably an amide-based lubricant. Specific examples of the amide-based lubricant include the same lubricants as those mentioned below for the heat-sealable resin layer 4.

When a lubricant is present on the surface of the base material layer 1, the amount of the lubricant present is not particularly limited, but is preferably about 3 mg/m² or more, more preferably about 4 to 15 mg/m², and still more preferably about 5 to 14 mg/m², in an environment at a temperature of 24° C. and a relative humidity of 60%.

A lubricant may be contained in the base material layer 1. The lubricant present on the surface of the base material layer 1 may be the lubricant that is contained in the resin constituting the base material layer 1 and exuded therefrom, or may be the lubricant applied to the surface of the base material layer 1.

While the thickness of the base material layer 1 is not particularly limited as long as the function as a base material layer is achieved, it is about 3 to 50 μm, and preferably about 10 to 35 μm.

[Adhesive Agent Layer 2]

In the battery packaging material 10 of the present invention, the adhesive agent layer 2 is a layer that is optionally provided between the base material layer 1 and the barrier layer 3, in order to strongly bond these layers.

The adhesive agent layer 2 is formed of an adhesive capable of bonding the base material layer 1 and the barrier layer 3. The adhesive to be used for forming the adhesive agent layer 2 may be a two-liquid curable adhesive or a one-liquid curable adhesive. Furthermore, the adhesive used for forming the adhesive agent layer 2 is not particularly limited, and may be any of a chemical reaction type, a solvent volatilization type, a heat melting type, a heat pressing type, and the like.

Specific examples of the adhesive component that can be used to form the adhesive agent layer 2 include polyester-based resins, such as polyethylene terephthalate, polybutylene terephthalate, polyethylene naphthalate, polybutylene naphthalate, polyethylene isophthalate, and copolyesters; polyether-based adhesives; polyurethane-based adhesives; epoxy-based resins; phenol resin-based resins; polycarbonate-based resins; polyamide-based resins, such as nylon 6, nylon 66, nylon 12, and copolyamides; polyolefin-based resins, such as polyolefins, carboxylic acid-modified polyolefins, and metal-modified polyolefins; polyvinyl acetate-based resins; cellulose-based adhesives; (meth)acrylic-based resins; polyimide-based resins; amino resins, such as urea resins and melamine resins; rubbers, such as chloroprene rubber, nitrile rubber, and styrene-butadiene rubber; and silicone-based resins. These adhesive components may be used alone or in combinations of two or more. Moreover, the resin that serves as the adhesive component can be used in combination with an appropriate curing agent to improve the adhesive strength. The curing agent is selected from appropriate curing agents, such as a polyisocyanate, a polyfunctional epoxy resin, an oxazoline group-containing polymer, a polyamine resin, and an acid anhydride, depending on the functional group of the adhesive component. Preferably, the adhesive component and the curing agent are a polyurethane-based adhesive containing any of various polyols and any of various polyisocyanates. More preferably, the adhesive component and the curing agent are a two-liquid curable polyurethane adhesive containing a polyol, such as a polyester polyol, a polyether polyol, or an acrylic polyol, as a base resin, and containing an aromatic or aliphatic polyisocyanate as a curing agent.

While the thickness of the adhesive agent layer 2 is not particularly limited as long as the function as an adhesive layer is achieved, it is about 1 to 10 μm, and preferably about 2 to 5 μm.

[Barrier Layer 3]

In the battery packaging material, the barrier layer 3 is a layer that functions to improve the strength of the battery packaging material, as well as prevent the ingress of water vapor, oxygen, light, and the like into the battery. The barrier layer 3 is preferably a metal layer, that is, a layer formed of a metal. Specific examples of the metal constituting the barrier layer 3 include aluminum, stainless steel, and titanium, and aluminum is preferred. The barrier layer 3 can be formed of, for example, a metal foil or a vapor-deposited metal film, or a film provided with such a vapor-deposited film. The barrier layer 3 is preferably formed of a metal foil, and more preferably formed of aluminum alloy foil. From the viewpoint of preventing the generation of creases or pinholes in the barrier layer 3 during the production of the battery packaging material, the barrier layer is preferably formed of soft aluminum alloy foil, for example, annealed aluminum (JIS H4160: 1994 A8021H-O, JIS H4160: 1994 A8079H-O, JIS H4000: 2014 A8021P-O, and JIS H4000: 2014 A8079P-O).

While the thickness of the barrier layer 3 is not particularly limited as long as the function as a barrier layer against water vapor and the like is achieved, it is preferably about 100 μm or less, more preferably about 10 to 100 μm, and still more preferably about 10 to 80 μm, from the viewpoint of reducing the thickness of the battery packaging material.

[Acid Resistance Films 3a and 3b]

The battery packaging material of the present invention comprises an acid resistance film on at least one surface of the barrier layer 3. The battery packaging material of the present invention may comprise the acid resistance film 3a on only the surface of the barrier layer 3 facing the heat-sealable resin layer 4, or may comprise the acid resistance film 3b on only the surface of the barrier layer 3 facing the base material layer 1, or may comprise the acid resistance films 3a and 3b on both surfaces of the barrier layer 3.

In the battery packaging material according to the first embodiment of the present invention, when the acid resistance film is analyzed using time-of-flight secondary ion mass spectrometry, a P_{PO3/CrPO4} ratio, which is the ratio of peak intensity P_{PO3} derived from PO₃⁻ to peak intensity P_{CrPO4} derived from CrPO₄⁻, falls within a range of 6 to 120. Because the peak intensity ratio falls within the specific range, the battery packaging material has excellent long-term adhesion of the barrier layer 3 to a layer adjacent to the side of the barrier layer 3 having the acid resistance film, even when an electrolytic solution adheres to the battery packaging material. Moreover, in the battery packaging material according to the first embodiment of the present invention, because the barrier layer having the acid resistance film can retain the adhesion over a long period, the battery packaging material is particularly useful as, for example, a packaging material for a large battery used in a vehicle.

In the battery packaging material according to the second embodiment of the present invention, when the acid resistance film is analyzed using time-of-flight secondary ion mass spectrometry, a P_{PO2/CrPO4} ratio, which is the ratio of peak intensity P_{PO2} derived from PO₂⁻ to peak intensity P_{CrPO4} derived from CrPO₄⁻, falls within a range of 7 to 70. Because the peak intensity ratio P_{PO2/CrPO4} falls within the specific range, the battery packaging material has excellent long-term adhesion of the barrier layer 3 to a layer adjacent to the side of the barrier layer 3 having the acid resistance film, even when an electrolytic solution adheres to the battery packaging material. Similarly, in the battery packaging material according to the second embodiment of the present invention, because the barrier layer having the acid resistance film can retain the adhesion over a long period, the battery packaging material is particularly useful as, for example, a packaging material for a large battery used in a vehicle.

In each of the first and second embodiments of the present invention, when the battery packaging material comprises the acid resistance films 3a and 3b on both surfaces of the barrier layer 3, the peak intensity ratio P_{PO3/CrPO4} or P_{PO2/CrPO4} for the acid resistance film in either one of the surfaces may fall within the above-defined range (that is, in the battery packaging material according to the first embodiment, the peak intensity ratio P_{PO3/CrPO4} may fall within the above-defined range, and in the battery packaging material according to the second embodiment, the peak intensity ratio P_{PO2/CrPO4} may fall within the above-defined range); however, it is preferred that the peak intensity ratio P_{PO3/CrPO4} or P_{PO2/CrPO4} for both acid resistance films 3a and 3b fall within the above-defined range. In particular, the adhesion between the acid resistance film positioned on the heat-sealable resin layer-facing side of the barrier layer and a layer adjacent thereto (such as the optional adhesive layer or the heat-sealable resin layer) is easily decreased by the penetration of the electrolytic solution. The battery packaging material of the present invention, therefore, preferably comprises the acid resistance film 3a on at least the surface of the barrier layer 3 facing the heat-sealable resin layer 4, and the peak intensity ratio P_{PO2/CrPO4} or P_{PO3/CrPO4} for the acid resistance film 3a preferably falls within the above-defined range. The same also applies to each of the peak intensity ratios given below.

In the first embodiment, the P_{PO3/CrPO4} ratio, which is the ratio of peak intensity P_{PO3} derived from PO₃⁻ to peak intensity P_{CrPO4} derived from CrPO₄⁻, may fall within the range of 6 to 120; however, from the viewpoint of further improving the long-term adhesion of the barrier layer having an acid resistance film, the lower limit of the P_{PO3/CrPO4} ratio is about 10 or more, for example, and the upper limit of the P_{PO3/CrPO4} ratio is preferably about 115 or less, more preferably about 110 or less, and still more preferably about 50 or less. The range of the P_{PO3/CrPO4} ratio is preferably from about 6 to 115, from about 6 to 110, from about 6 to 50, from about 10 to 120, from about 10 to 115, from about 10 to 110, or from about 10 to 50.

In the second embodiment, the P_{PO2/CrPO4} ratio, which is the ratio of peak intensity P_{PO2} derived from PO₂⁻ to peak intensity P_{CrPO4} derived from CrPO₄⁻, may fall within the range of 7 to 70; however, from the viewpoint of further improving the long-term adhesion of the barrier layer having an acid resistance film, the lower limit of the P_{PO2/CrPO4} ratio is preferably about 10 or more, for example, and the upper limit of the P_{PO2/CrPO4} ratio is preferably about 65 or less, and more preferably about 25 or less. The range of the P_{PO2/CrPO4} ratio is preferably from about 7 to 65, from about 7 to 25, from about 10 to 70, from about 10 to 65, or from about 10 to 25.

Furthermore, in the first embodiment as well, when the acid resistance film is analyzed using time-of-flight secondary ion mass spectrometry, the lower limit of the P_{PO2/CrPO4} ratio, which is the ratio of peak intensity P_{PO2} derived from PO₂⁻ to peak intensity P_{CrPO4} derived from CrPO₄⁻, is preferably about 7 or more, for example, and the upper limit of the P_{PO2/CrPO4} ratio is preferably about 70 or less, and more preferably about 65 or less. In the first embodiment, the range of the P_{PO2/CrPO4} ratio is preferably about 7 to 70, and more preferably about 7 to 65.

Specifically, the analysis of the acid resistance films 3a and 3b using time-of-flight secondary ion mass spectrometry may be performed using a time-of-flight secondary ion mass spectrometer, under the following measurement conditions:

(Measurement Conditions)

Primary ion: doubly charged ion of bismuth cluster (Bi₃⁺⁺)

Primary ion acceleration voltage: 30 kV

Mass range (m/z): 0-1500

Measurement range: 100 μm×100 μm

Number of scans: 16 scans/cycle

Number of pixels (per side): 256 pixels

Etching ion: Ar gas cluster ion beam (Ar-GCIB)

Etching ion acceleration voltage: 5.0 kV

The inclusion of chromium in the acid resistance film can be confirmed using X-ray photoelectron spectroscopy. Specifically, initially, in the battery packaging material, the layers laminated on the barrier layer (such as the adhesive agent layer, the heat-sealable resin layer, and the adhesive layer) are physically peeled off. Subsequently, the barrier layer is placed in an electric furnace at about 300° C. for about 30 minutes to eliminate organic components present on the surface of the barrier layer. Then, the inclusion of chromium is confirmed using X-ray photoelectron spectroscopy on the surface of the barrier layer.

The acid resistance films 3a and 3b can be formed by subjecting the surfaces of the barrier layer 3 to a chemical conversion treatment with a treatment solution containing a chromium compound, such as chromium oxide.

Examples of the method of the chemical conversion treatment using a treatment solution containing a chromium compound include a method in which a dispersion of a chromium compound such as chromium oxide in phosphoric acid and/or a salt thereof is applied to a surface of the barrier layer 3, and subjected to a baking treatment to form an acid resistance film on a surface of the barrier layer 3.

The peak intensity ratio P_{PO3/CrPO4} or P_{PO2/CrPO4} for the acid resistance films 3a and 3b can be adjusted by adjusting, for example, the composition of the treatment solution for forming the acid resistance films 3a and 3b, and production conditions such as the temperature and the time of the baking treatment after the treatment.

In the treatment solution containing a chromium compound, the proportion of phosphoric acid and/or a salt thereof to the chromium compound is not particularly limited; however, from the viewpoint of setting the peak intensity ratio P_{PO3/CrPO4} or P_{PO2/CrPO4} within the above-defined range, the proportion of phosphoric acid and/or a salt thereof per 100 parts by mass of the chromium compound is preferably about 30 to 120 parts by mass, and more preferably about 40 to 110 parts by mass. Condensed phosphoric acid and a salt thereof, for example, may be used as phosphoric acid and a salt thereof.

The treatment solution containing a chromium compound may also contain an anionic polymer and a crosslinking agent that crosslinks the anionic polymer. Examples of the anionic polymer include a copolymer that contains, as a main component, poly(meth)acrylic acid or a salt thereof, or (meth)acrylic acid or a salt thereof. Examples of the crosslinking agent include a silane coupling agent and a compound having, as a functional group, any of an isocyanate group, a glycidyl group, a carboxyl group, and an oxazoline group. A single anionic polymer or two or more anionic polymers may be used. Similarly, a single crosslinking agent or two or more crosslinking agents may be used.

From the viewpoint of improving the long-term adhesion of the barrier layer having an acid resistance film while achieving excellent acid resistance, the treatment solution containing a chromium compound preferably contains an aminated phenol polymer. The amount of the aminated phenol polymer contained in the treatment solution containing a chromium compound is preferably about 100 to 400 parts by mass, and more preferably about 200 to 300 parts by mass, per 100 parts by mass of the chromium compound. The weight average molecular weight of the aminated phenol polymer is preferably about 5,000 to 20,000. The weight average molecular weight of the aminated phenol polymer is the value measured by gel permeation chromatography (GPC), which is measured by using polystyrene as standard samples.

The solvent for the treatment solution containing a chromium compound is not particularly limited as long as it is a solvent capable of dispersing the component contained in the treatment solution, and being evaporated by subsequent heating; however, the solvent is preferably water. The solids concentration of the treatment solution containing a chromium compound is about 1 to 15% by mass, for example. When the treatment solution is applied to a surface of the barrier layer and heated to form an acid resistance film, the surface temperature of the barrier layer is preferably about 190 to 220° C., for example, and the heating time is preferably about 3 to 6 seconds. By adopting the temperature and the heating time, an acid resistance film layer can be favorably formed by evaporating the solvent appropriately.

While the solids concentration of the chromium compound contained in the treatment solution for forming an acid resistance film is not particularly limited, it is preferably about 7.0 to 12.0% by mass, more preferably about 8.0 to 11.0% by mass, and still more preferably about 9.0 to 10.0% by mass, from the viewpoint of setting the peak intensity ratio P_{PO3/CrPO4} or P_{PO2/CrPO4} in the predetermined range described above, and improving the long-term adhesion of the barrier layer having an acid resistance film while achieving excellent acid resistance.

While the thickness of the acid resistance film is not particularly limited, it is preferably about 1 nm to 10 μm, more preferably about 1 to 100 nm, and still more preferably about 1 to 50 nm, from the viewpoint of improving the long-term adhesion of the barrier layer having an acid resistance film while achieving excellent acid resistance. The thickness of the acid resistance film can be measured by observation with a transmission electron microscope, or a combination thereof with energy dispersive X-ray spectroscopy or electron energy loss spectroscopy.

From the same viewpoint, the amount of the acid resistance film per m² of the surface of the barrier layer 3 is preferably about 1 to 500 mg, more preferably about 1 to 100 mg, and still more preferably about 1 to 50 mg.

Examples of the method for applying the treatment solution containing a chromium compound to a surface of the barrier layer include a bar coating method, a roll coating method, a gravure coating method, and an immersion method.

From the viewpoint of setting the peak intensity ratio P_{PO3/CrPO4} or P_{PO2/CrPO4} in the predetermined range described above, and improving the long-term adhesion of the barrier layer having an acid resistance film while achieving excellent acid resistance, the heating temperature when the treatment solution is baked to form an acid resistance film is preferably about 170 to 250° C., and more preferably about 180 to 230° C. From the same viewpoint, the baking time is preferably about 2 to 10 seconds, and more preferably about 3 to 6 seconds.

From the viewpoint of performing the chemical conversion treatment of a surface of the barrier layer more efficiently, it is preferred that prior to providing an acid resistance film on the surface of the barrier layer 3, a degreasing treatment be performed using a known treatment method, such as an alkali immersion method, an electrolytic cleaning method, an acid cleaning method, an electrolytic acid cleaning method, or an acid activation method.

[Heat-Sealable Resin Layer 4]

In the battery packaging material of the present invention, the heat-sealable resin layer 4 corresponds to an innermost layer, and is a layer that is heat-sealed with itself during the assembly of a battery to hermetically seal the battery element.

While the resin component to be used for the heat-sealable resin layer 4 is not particularly limited as long as it can be heat-sealed, examples include a polyolefin, a cyclic polyolefin, an acid-modified polyolefin, and an acid-modified cyclic polyolefin. That is, the resin constituting the heat-sealable resin layer 4 may contain a polyolefin backbone, and preferably contains a polyolefin backbone. The inclusion of the polyolefin backbone in the resin constituting the heat-sealable resin layer 4 can be analyzed by, for example, infrared spectroscopy or gas chromatography-mass spectrometry, although the analytical method is not particularly limited. For example, when a maleic anhydride-modified polyolefin is measured by infrared spectroscopy, peaks derived from maleic anhydride are detected at a wavelength near 1760 cm⁻¹ and a wavelength near 1780 cm⁻¹. However, if the degree of acid modification is low, the peaks may be so small that they cannot be detected. In that case, the analysis can be performed by nuclear magnetic resonance spectroscopy.

Specific examples of the polyolefin include polyethylene, such as low-density polyethylene, medium-density polyethylene, high-density polyethylene, and linear low-density polyethylene; polypropylene, such as homopolypropylene, block copolymers of polypropylene (for example, block copolymers of propylene and ethylene), and random copolymers of polypropylene (for example, random copolymers of propylene and ethylene); and terpolymers of ethylene-butene-propylene. Among these polyolefins, polyethylene and polypropylene are preferred.

The cyclic polyolefin is a copolymer of an olefin and a cyclic monomer. Examples of the olefin as a constituent monomer of the cyclic polyolefin include ethylene, propylene, 4-methyl-1-pentene, butadiene, and isoprene. Examples of the cyclic monomer as a constituent monomer of the cyclic polyolefin include cyclic alkenes, such as norbornene; specifically, cyclic dienes, such as cyclopentadiene, dicyclopentadiene, cyclohexadiene, and norbornadiene. Among these polyolefins, cyclic alkenes are preferred, and norbornene is more preferred.

The acid-modified polyolefin is a polymer obtained by modifying the polyolefin by block copolymerization or graft copolymerization with an acid component, such as a carboxylic acid. Examples of the acid component to be used for the modification include carboxylic acids, such as maleic acid, acrylic acid, itaconic acid, crotonic acid, maleic anhydride, and itaconic anhydride, or anhydrides thereof.

The acid-modified cyclic polyolefin is a polymer obtained by replacing a portion of the monomers constituting the cyclic polyolefin with an α,β-unsaturated carboxylic acid or an anhydride thereof, and copolymerizing them, or by block-copolymerizing or graft-copolymerizing an α,β-unsaturated carboxylic acid or an anhydride thereof onto the cyclic polyolefin. The cyclic polyolefin to be modified with a carboxylic acid is the same as described above. The carboxylic acid to be used for the modification is the same as that used for the modification of the polyolefin.

Among these resin components, preferred is a polyolefin, such as polypropylene, or a carboxylic acid-modified polyolefin; and more preferred is polypropylene or acid-modified polypropylene.

The heat-sealable resin layer 4 may be formed using one resin component alone, or may be formed using a blend polymer obtained by combining two or more resin components. Furthermore, the heat-sealable resin layer 4 may be formed of only one layer, or may be formed of two or more layers composed of an identical resin component or different resin components.

In the present invention, from the viewpoint of improving the moldability of the battery packaging material, a lubricant is preferably adhered to the surface of the heat-sealable resin layer. While the lubricant is not particularly limited, it is preferably an amide-based lubricant. Specific examples of the amide-based lubricant include saturated fatty acid amides, unsaturated fatty acid amides, substituted amides, methylol amides, saturated fatty acid bis-amides, and unsaturated fatty acid bis-amides. Specific examples of saturated fatty acid amides include lauramide, palmitamide, stearamide, behenamide, and hydroxystearamide. Specific examples of unsaturated fatty acid amides include oleamide and erucamide. Specific examples of substituted amides include N-oleyl palmitamide, N-stearyl stearamide, N-stearyl oleamide, N-oleyl stearamide, and N-stearyl erucamide. Specific examples of methylol amides include methylol stearamide. Specific examples of saturated fatty acid bis-amides include methylene-bis-stearamide, ethylene-bis-capramide, ethylene-bis-lauramide, ethylene-bis-stearamide, ethylene-bis-hydroxystearamide, ethylene-bis-behenamide, hexamethylene-bis-stearamide, hexamethylene-bis-behenamide, hexamethylene hydroxystearamide, N,N′-distearyl adipamide, and N,N′-distearyl sebacamide. Specific examples of unsaturated fatty acid bis-amides include ethylene-bis-oleamide, ethylene-bis-erucamide, hexamethylene-bis-oleamide, N,N′-dioleyl adipamide, and N,N′-dioleyl sebacamide. Specific examples of fatty acid ester amides include stearamide ethyl stearate. Specific examples of aromatic bis-amides include m-xylylene-bis-stearamide, m-xylylene-bis-hydroxystearamide, and N,N′-distearyl isophthalamide. These lubricants may be used alone or in combinations of two or more.

When a lubricant is present on the surface of the heat-sealable resin layer 4, the amount of the lubricant present is not particularly limited, but is preferably about 3 mg/m² or more, more preferably about 4 to 15 mg/m², and still more preferably about 5 to 14 mg/m², in an environment at a temperature of 24° C. and a relative humidity of 60%.

A lubricant may be contained in the heat-sealable resin layer 4. The lubricant present on the surface of the heat-sealable resin layer 4 may be the lubricant that is contained in the resin constituting the heat-sealable resin layer 4 and exuded therefrom, or may be the lubricant applied to the surface of the heat-sealable resin layer 4.

While the thickness of the heat-sealable resin layer 4 is not particularly limited as long as the function as a heat-sealable resin layer is achieved, it is preferably about 60 μm or less, more preferably about 15 to 60 μm, and still more preferably about 15 to 40 μm.

[Adhesive Layer 5]

In the battery packaging material of the present invention, the adhesive layer 5 is a layer that is optionally provided between the barrier layer 3 and the heat-sealable resin layer 4, in order to improve the adhesion between these layers. The adhesive layer 5 may be composed of a single layer, or may be composed of a plurality of identical or different layers.

In general, from the viewpoint of improving the adhesion between a barrier layer and a heat-sealable resin layer, it is preferred to have an adhesive layer between these layers; however, when an acid resistance film is provided on a surface of the barrier layer facing the heat-sealable resin layer, there is a drawback in that the long-term adhesion between the acid resistance film and the adhesive layer easily decreases. As opposed to this, in the battery packaging material of the present invention, because the acid resistance film has the above-specified peak intensity ratio P_{PO3/CrPO4} or P_{PO2/CrPO4}, excellent adhesion is achieved, and the long-term adhesion between the acid resistance film 3a and the adhesive layer 5 is also effectively improved. That is, in an embodiment of the battery packaging material of the present invention in which the acid resistance film 3a on the surface of the barrier layer 3 and the heat-sealable resin layer 4 are laminated with the adhesive layer 5 interposed therebetween, the effect of having excellent long-term adhesion of the barrier layer having the acid resistance film can be particularly effectively achieved.

The adhesive layer 5 is formed of a resin capable of bonding the barrier layer 3 (and the acid resistance film 3a) and the heat-sealable resin layer 4. As the resin to be used for forming the adhesive layer 5, the same adhesive as that mentioned for the adhesive agent layer 2, in terms of adhesion mechanism, type of adhesive component, and the like, can be used. Furthermore, as the resin to be used for forming the adhesive layer 5, polyolefin-based resins mentioned above for the heat-sealable resin layer 4, such as a polyolefin, a cyclic polyolefin, a carboxylic acid-modified polyolefin, and a carboxylic acid-modified cyclic polyolefin, can be used. From the viewpoint of achieving excellent adhesion between the barrier layer 3 and the heat-sealable resin layer 4, the polyolefin is preferably a carboxylic acid-modified polyolefin, and particularly preferably carboxylic acid-modified polypropylene. That is, the resin constituting the adhesive layer 5 may contain a polyolefin backbone, and preferably contains a polyolefin backbone. The inclusion of the polyolefin backbone in the resin constituting the adhesive layer 5 can be analyzed by, for example, infrared spectroscopy or gas chromatography-mass spectrometry, although the analytical method is not particularly limited. For example, when a maleic anhydride-modified polyolefin is measured by infrared spectroscopy, peaks derived from maleic anhydride are detected at a wavelength near 1760 cm⁻¹ and a wavelength near 1780 cm⁻¹. However, if the degree of acid modification is low, the peaks may be so small that they cannot be detected. In that case, the analysis can be performed by nuclear magnetic resonance spectroscopy.

Furthermore, from the viewpoint of achieving a battery packaging material having excellent shape stability after molding, while reducing the thickness of the battery packaging material, the adhesive layer 5 may be a cured product of a resin composition containing an acid-modified polyolefin and a curing agent. Preferred examples of the acid-modified polyolefin include the same carboxylic acid-modified polyolefin and carboxylic acid-modified cyclic polyolefin as mentioned for the heat-sealable resin layer 4.

The curing agent is not particularly limited as long as it cures the acid-modified polyolefin. Examples of the curing agent include an epoxy-based curing agent, a polyfunctional isocyanate-based curing agent, a carbodiimide-based curing agent, and an oxazoline-based curing agent.

The epoxy-based curing agent is not particularly limited as long as it is a compound having at least one epoxy group. Examples of the epoxy-based curing agent include epoxy resins, such as bisphenol A diglycidyl ether, modified bisphenol A diglycidyl ether, novolac glycidyl ether, glycerol polyglycidyl ether, and polyglycerol polyglycidyl ether.

The polyfunctional isocyanate-based curing agent is not particularly limited as long as it is a compound having two or more isocyanate groups. Specific examples of the polyfunctional isocyanate-based curing agent include isophorone diisocyanate (IPDI), hexamethylene diisocyanate (HDI), tolylene diisocyanate (TDI), diphenylmethane diisocyanate (MDI), polymer or isocyanurate forms thereof, mixtures thereof, and copolymers thereof with other polymers.

The carbodiimide-based curing agent is not particularly limited as long as it is a compound having at least one carbodiimide group (—N=C═N—). The carbodiimide-based curing agent is preferably a polycarbodiimide compound having at least two carbodiimide groups.

The oxazoline-based curing agent is not particularly limited as long as it is a compound having an oxazoline backbone (oxazoline group). Specific examples of the compound having an oxazoline group include those having a polystyrene main chain and those having an acrylic main chain. Specific examples of the oxazoline-based curing agent include the Epocros series manufactured by Nippon Shokubai Co., Ltd.

From the viewpoint of improving the adhesion between the barrier layer 3 and the heat-sealable resin layer 4 by means of the adhesive layer 5, the curing agent may be composed of two or more compounds.

The content of the curing agent in the resin composition for forming the adhesive layer 5 is preferably in the range from about 0.1 to 50% by mass, more preferably from about 0.1 to 30% by mass, and still more preferably from about 0.1 to 10% by mass.

Preferably, the adhesive layer 5 is a cured product of a resin composition containing an acid-modified polyolefin, and containing at least one selected from the group consisting of a compound having an isocyanate group, a compound having an oxazoline group, and a compound having an epoxy group. Particularly preferably, the adhesive layer 5 is a cured product of a resin composition containing an acid-modified polyolefin, and containing at least one selected from the group consisting of a compound having an isocyanate group and a compound having an epoxy group. Moreover, the adhesive layer 5 preferably contains at least one selected from the group consisting of a urethane resin, an ester resin, and an epoxy resin, and more preferably contains a urethane resin and an epoxy resin. The ester resin is preferably an amide ester resin, for example. The amide ester resin is typically produced by reacting a carboxyl group and an oxazoline group. More preferably, the adhesive layer 5 is a cured product of a resin composition containing at least one of these resins and the above-described acid-modified polyolefin. When unreacted matter of the curing agent such as the compound having an isocyanate group, the compound having an oxazoline group, or the compound having an epoxy group remains in the adhesive layer 5, the presence of the unreacted matter can be confirmed using a method selected from, for example, infrared spectroscopy, Raman spectroscopy, and time-of-flight secondary ion mass spectrometry (TOF-SIMS).

Moreover, from the viewpoint of further improving the adhesion between the acid resistance film 3a and the adhesive layer 5, the adhesive layer 5 is preferably a cured product of a resin composition containing a curing agent having at least one selected from the group consisting of an oxygen atom, a heterocyclic ring, a C═N bond, and a C—O—C bond. Examples of the curing agent having a heterocyclic ring include a curing agent having an oxazoline group and a curing agent having an epoxy group. Examples of the curing agent having a C═N bond include a curing agent having an oxazoline group and a curing agent having an isocyanate group. Examples of the curing agent having a C—O—C bond include a curing agent having an oxazoline group, a curing agent having an epoxy group, and a urethane resin. The fact that the adhesive layer 5 is a cured product of a resin composition containing the above-described curing agent can be confirmed using a method such as, for example, gas chromatography-mass spectrometry (GCMS), infrared spectroscopy (IR), time-of-flight secondary ion mass spectrometry (TOF-SIMS), or X-ray photoelectron spectroscopy (XPS).

While the compound having an isocyanate group is not particularly limited, it is preferably a polyfunctional isocyanate compound, from the viewpoint of effectively improving the adhesion between the acid resistance film 3a and the adhesive layer 5. The polyfunctional isocyanate compound is not particularly limited as long as it is a compound having two or more isocyanate groups. Specific examples of the polyfunctional isocyanate-based curing agent include those mentioned above.

The content of the compound having an isocyanate group in the resin composition constituting the adhesive layer 5 is preferably in the range from 0.1 to 50% by mass, and more preferably from 0.5 to 40% by mass. This can effectively improve the adhesion between the acid resistance film 3a and the adhesive layer 5.

The compound having an oxazoline group is not particularly limited as long as it is a compound having an oxazoline backbone. Specific examples of the compound having an oxazoline group include those having a polystyrene main chain and those having an acrylic main chain. Examples of commercial products include those mentioned above.

The content of the compound having an oxazoline group in the resin composition constituting the adhesive layer 5 is preferably in the range from 0.1 to 50% by mass, and more preferably from 0.5 to 40% by mass. This can effectively improve the adhesion between the acid resistance film 3a and the adhesive layer 5.

The epoxy resin is not particularly limited as long as it is a resin capable of forming a crosslinked structure through an epoxy group present in the molecule, and a known epoxy resin can be used. The weight average molecular weight of the epoxy resin is preferably about 50 to 2,000, more preferably about 100 to 1,000, and still more preferably about 200 to 800. As used herein, the weight average molecular weight of the epoxy resin is the value measured by gel permeation chromatography (GPC), which is measured by using polystyrene as standard samples.

Specific examples of the epoxy resin include glycidyl ether derivative of trimethylolpropane, bisphenol A diglycidyl ether, modified bisphenol A diglycidyl ether, novolac glycidyl ether, glycerol polyglycidyl ether, and polyglycerol polyglycidyl ether. These epoxy resins may be used alone or in combinations of two or more.

The content of the epoxy resin in the resin composition constituting the adhesive layer 5 is preferably in the range from 0.1 to 50% by mass, and more preferably from 0.5 to 40% by mass. This can effectively improve the adhesion between the acid resistance film 3a and the adhesive layer 5.

In the present invention, when the adhesive layer 5 is a cured product of a resin composition containing at least one selected from the group consisting of a compound having an isocyanate group, a compound having an oxazoline group, and an epoxy resin, and containing the above-described acid-modified polyolefin, the acid-modified polyolefin functions as a base resin, and each of the compound having an isocyanate group, the compound having an oxazoline group, and the epoxy resin functions as a curing agent.

The thickness of the adhesive layer 5 is not particularly limited as long as the function as an adhesive layer is achieved. When any of the adhesives mentioned for the adhesive agent layer 2 is used, the thickness of the adhesive layer 5 is preferably about 1 to 10 μm, and more preferably about 1 to 5 μm. When any of the resins mentioned for the heat-sealable resin layer 4 is used, the thickness of the adhesive layer 5 is preferably about 2 to 50 μm, and more preferably about 10 to 40 μm. When the cured product of an acid-modified polyolefin and a curing agent is used, the thickness of the adhesive layer 5 is preferably about 30 μm or less, more preferably about 0.1 to 20 μm, and still more preferably about 0.5 to 5 μm. When the adhesive layer 5 is the cured product of a resin composition containing an acid-modified polyolefin and a curing agent, the adhesive layer 5 can be formed by applying the resin composition, and curing the composition by heating or the like.

[Surface Coating Layer 6]

The battery packaging material of the present invention may optionally include the surface coating layer 6 on the outer side of the base material layer 1 (opposite to the barrier layer 3 on the base material layer 1), for the purpose of enhancing the designability, electrolytic solution resistance, scratch resistance, and moldability, for example. When the surface coating layer 6 is provided, it is an outermost layer of the battery packaging material.

The surface coating layer 6 can be formed using, for example, polyvinylidene chloride, a polyester resin, a urethane resin, an acrylic resin, or an epoxy resin. In particular, the surface coating layer 6 is preferably formed using a two-liquid curable resin. Examples of the two-liquid curable resin that forms the surface coating layer 6 include a two-liquid curable urethane resin, a two-liquid curable polyester resin, and a two-liquid curable epoxy resin. An additive may also be blended into the surface coating layer.

Examples of the additive include fine particles having a particle diameter of about 0.5 nm to 5 μm. While the material of the additive is not particularly limited, examples include metals, metal oxides, inorganic materials, and organic materials. Moreover, while the shape of the additive is not particularly limited, examples include a spherical shape, a fibrous shape, a plate shape, an amorphous shape, and a balloon shape. Specific examples of the additive include talc, silica, graphite, kaolin, montmorilloide, montmorillonite, synthetic mica, hydrotalcite, silica gel, zeolite, aluminum hydroxide, magnesium hydroxide, zinc oxide, magnesium oxide, aluminum oxide, neodymium oxide, antimony oxide, titanium oxide, cerium oxide, calcium sulfate, barium sulfate, calcium carbonate, calcium silicate, lithium carbonate, calcium benzoate, calcium oxalate, magnesium stearate, alumina, carbon black, carbon nanotubes, high-melting-point nylons, crosslinked acrylics, crosslinked styrene, crosslinked polyethylene, benzoguanamine, gold, aluminum, copper, and nickel. These additives may be used alone or in combinations of two or more. Among these additives, silica, barium sulfate, and titanium oxide are preferred from the viewpoint of dispersion stability, costs, and the like. The surface of the additive may be subjected to various types of surface treatments, such as an insulation treatment and a dispersibility enhancing treatment.

While the content of the additive in the surface coating layer 6 is not particularly limited, it is preferably about 0.05 to 1.0% by mass, and more preferably about 0.1 to 0.5% by mass.

Examples of the method for forming the surface coating layer 6 include, although not particularly limited to, a method in which the two-liquid curable resin for forming the surface coating layer is applied to the outer surface of the base material layer 1. When an additive is to be blended, the additive may be mixed into the two-liquid curable resin, and then the mixture may be applied.

While the thickness of the surface coating layer 6 is not particularly limited as long as the above-described function as the surface coating layer 6 is achieved, it is about 0.5 to 10 μm, and preferably about 1 to 5 μm.

3. Method for Producing Battery Packaging Material

The method for producing the battery packaging material of the present invention is not particularly limited as long as a laminate including the layers each having a predetermined composition is obtained. Examples of the method for producing the battery packaging material according to the first embodiment include a method comprising the step of obtaining a laminate by laminating at least a base material layer, a barrier layer, and a heat-sealable resin layer in this order, wherein when the barrier layer is laminated, the barrier layer comprises an acid resistance film on at least one surface thereof, and when the acid resistance film is analyzed using time-of-flight secondary ion mass spectrometry, a P_{PO3/CrPO4} ratio, which is the ratio of peak intensity P_{PO3} derived from PO₃⁻ to peak intensity P_{CrPO4} derived from CrPO₄⁻, falls within a range of 6 to 120.

Examples of the method for producing the battery packaging material according to the second embodiment include a method comprising the step of obtaining a laminate by laminating at least a base material layer, a barrier layer, and a heat-sealable resin layer in this order, wherein when the barrier layer is laminated, the barrier layer comprises an acid resistance film on at least one surface thereof, and when the acid resistance film is analyzed using time-of-flight secondary ion mass spectrometry, a P_{PO2/CrPO4} ratio, which is the ratio of peak intensity P_{PO2} derived from PO₂⁻ to peak intensity P_{CrPO4} derived from CrPO₄⁻, falls within a range of 7 to 70.

One example of the method for producing the battery packaging material of the present invention is as follows: Initially, a laminate including the base material layer 1, the optional adhesive agent layer 2, and the barrier layer 3 in this order (the laminate may be hereinafter denoted as the “laminate A”) is formed. Specifically, the laminate A can be formed using a dry lamination method as follows: The adhesive to be used for forming the adhesive agent layer 2 is applied to the base material layer 1 or to the barrier layer 3 (or to the acid resistance film 3a when the barrier layer 3 has the acid resistance film 3a; this is omitted hereinafter), using a coating method such as a gravure coating method or a roll coating method, and dried. Then, the barrier layer 3 or the base material layer 1 is laminated thereon, and the adhesive agent layer 2 is cured. At this time, when the barrier layer 3 is laminated, a barrier layer having at least one surface on which the above-described acid resistance film has been formed in advance is used as the barrier layer 3. The method for forming the acid resistance films 3a and 3b is as described above.

Subsequently, the heat-sealable resin layer 4 is laminated on the barrier layer 3 of the laminate A. When the heat-sealable resin layer 4 is laminated directly on the barrier layer 3, the resin component that forms the heat-sealable resin layer 4 may be applied onto the barrier layer 3 of the laminate A, using a method such as a gravure coating method or a roll coating method. When the adhesive layer 5 is provided between the barrier layer 3 and the heat-sealable resin layer 4, examples of the method therefor include the following: (1) a method in which the adhesive layer 5 and the heat-sealable resin layer 4 are co-extruded to be laminated on the barrier layer 3 of the laminate A (co-extrusion lamination method); (2) a method in which a laminate in which the adhesive layer 5 and the heat-sealable resin layer 4 are laminated is separately formed, and this laminate is laminated on the barrier layer 3 of the laminate A using a thermal lamination method; (3) a method in which the adhesive for forming the adhesive layer 5 is laminated on the barrier layer 3 of the laminate A by, for example, applying the adhesive onto the barrier layer 3 using an extrusion method or solution coating, followed by drying at a high temperature and baking, and then the heat-sealable resin layer 4 formed into a sheet in advance is laminated on the adhesive layer 5 using a thermal lamination method; and (4) a method in which the melted adhesive layer 5 is poured between the barrier layer 3 of the laminate A and the heat-sealable resin layer 4 formed into a sheet in advance, and simultaneously the laminate A and the heat-sealable resin layer 4 are bonded with the adhesive layer 5 interposed therebetween (sandwich lamination method).

When the surface coating layer 6 is to be provided, the surface coating layer is laminated on the surface of the base material layer 1 opposite to the barrier layer 3. The surface coating layer can be formed by, for example, applying the above-described resin that forms the surface coating layer onto the surface of the base material layer 1. The order of the step of laminating the barrier layer 3 on the surface of the base material layer 1 and the step of laminating the surface coating layer on the surface of the base material layer 1 is not particularly limited. For example, the surface coating layer may be formed on the surface of the base material layer 1, and then the barrier layer 3 may be formed on the surface of the base material layer 1 opposite to the surface coating layer.

In the manner as described above, a laminate is formed that includes the optional surface coating layer 6/the base material layer 1/the optional adhesive agent layer 2/the barrier layer 3 having an acid resistance film on at least one surface thereof/the optional adhesive layer 5/the heat-sealable resin layer 4. The laminate may further be subjected to a heat treatment of a heat-roll contact type, a hot-air type, or a near- or far-infrared radiation type, in order to strengthen the adhesiveness of the optional adhesive agent layer 2 or adhesive layer 5.

In the battery packaging material of the present invention, the layers constituting the laminate may be optionally subjected to a surface activation treatment, such as a corona treatment, a blast treatment, an oxidation treatment, or an ozone treatment, in order to improve or stabilize the film formability, the lamination processing, the suitability for final product secondary processing (pouching and embossing molding), and the like.

4. Use of Battery Packaging Material

The battery packaging material of the present invention is used as a package for hermetically sealing and housing a battery element including a positive electrode, a negative electrode, and an electrolyte. That is, a battery can be provided by housing a battery element comprising at least a positive electrode, a negative electrode, and an electrolyte in a package formed of the battery packaging material of the present invention. To analyze the above-described peak intensities and the like in the battery packaging material of the present invention, the battery packaging material may be cut from a battery. When the battery packaging material is cut from a battery, a sample is obtained from a portion of the battery where the heat-sealable resin layer is not heat-sealed with itself, such as the top surface or bottom surface, and then subjected to the analysis.

Specifically, a battery element comprising at least a positive electrode, a negative electrode, and an electrolyte is covered with the battery packaging material of the present invention such that a flange portion (region where the heat-sealable resin layer is brought into contact with itself) can be formed on the periphery of the battery element, with the metal terminal connected to each of the positive electrode and the negative electrode protruding to the outside. Then, the heat-sealable resin layer in the flange portion is heat-sealed with itself to hermetically seal the battery element. As a result, a battery is provided using the battery packaging material. When the battery element is housed in the package formed of the battery packaging material of the present invention, the package is formed such that the heat-sealable resin layer portion of the battery packaging material of the present invention is positioned on the inner side (surface that contacts the battery element).

The battery packaging material of the present invention may be used for either primary batteries or secondary batteries, preferably secondary batteries. While the type of secondary battery to which the battery packaging material of the present invention is applied is not particularly limited, examples include lithium ion batteries, lithium ion polymer batteries, lead storage batteries, nickel-hydrogen storage batteries, nickel-cadmium storage batteries, nickel-iron storage batteries, nickel-zinc storage batteries, silver oxide-zinc storage batteries, metal-air batteries, polyvalent cation batteries, condensers, and capacitors. Among these secondary batteries, preferred secondary batteries to which the battery packaging material of the present invention is applied include lithium ion batteries and lithium ion polymer batteries.

In the battery packaging material of the present invention, the barrier layer having the acid resistance film can retain the adhesion over a long period. The battery packaging material of the present invention, therefore, is particularly useful as, for example, a packaging material for a large battery used in a vehicle such as a hybrid car or an electric car.

### EXAMPLES

The present invention will be hereinafter described in detail with reference to examples and comparative examples; however, the present invention is not limited to the examples.

<Production of Battery Packaging Materials>

### Example 1

To a surface of a biaxially stretched nylon film (25 μm) as a base material layer, a barrier layer composed of aluminum foil (JIS H4160: 1994 A8021H-O, thickness: 40 μm), whose both surfaces had been subjected to a chemical conversion treatment using the below-described method to have acid resistance films (thickness: 10 nm) thereon, was laminated using the dry lamination method. Specifically, a two-liquid urethane adhesive (a polyol compound and an aromatic isocyanate-based compound) was applied to one surface of the aluminum foil having an acid resistance film to form an adhesive agent layer (thickness: 3 μm). Subsequently, the adhesive agent layer on the barrier layer having an acid resistance film and the biaxially stretched nylon film of the base material layer were laminated, and then the laminate was subjected to an aging treatment to prepare a laminate having the biaxially stretched nylon film/the adhesive agent layer/the barrier layer having acid resistance films on both surfaces.

Subsequently, maleic anhydride-modified polypropylene and random polypropylene were co-extruded to laminate the maleic anhydride-modified polypropylene (23 μm) as an adhesive layer and the random polypropylene (23 μm) as a heat-sealable resin layer on the barrier layer of the laminate. Subsequently, the resulting laminate was subjected to aging to obtain a battery packaging material in which the biaxially stretched nylon film (25 μm)/the adhesive agent layer (3 μm)/the barrier layer (40 μm) having acid resistance films (10 nm) on both surfaces/the maleic anhydride-modified polypropylene (23 μm)/the random polypropylene (23 μm) were laminated in this order.

The acid resistance films on the surfaces of the barrier layer were formed as follows: A treatment solution was prepared containing 43 parts by mass of an aminated phenol polymer, 16 parts by mass of chromium fluoride, and 13 parts by mass of phosphoric acid, per 100 parts by mass of water. The treatment solution was applied (film thickness after drying: 10 nm) to both surfaces of the barrier layer, and dried by heating for about 3 to 6 seconds at a temperature such that the surface temperature of the barrier layer became about 190 to 230° C.

### Example 2

As a base material layer, a laminated film was prepared in which a biaxially stretched polyethylene terephthalate film (thickness: 12 μm) and a biaxially stretched nylon film (thickness: 15 μm) were laminated using the dry lamination method. In the laminated film, the biaxially stretched polyethylene terephthalate film and the biaxially stretched nylon film were bonded with a urethane-based adhesive composed of a polyol and an isocyanate-based curing agent (thickness after curing: 3 μm). Subsequently, metal foil composed of aluminum foil (JIS H4160: 1994 A8021H-O, thickness: 40 μm), whose both surfaces had been subjected to a chemical conversion treatment as in Example 1 to have acid resistance films (thickness: 10 nm) thereon, was laminated to the biaxially stretched nylon film side, using the dry lamination method. Specifically, a two-liquid urethane adhesive (a polyol compound and an aromatic isocyanate-based compound) was applied to one surface of the aluminum foil having an acid resistance film to form an adhesive agent layer (thickness: 3 μm) on the barrier layer having an acid resistance film (thickness: 10 nm). Subsequently, the adhesive agent layer on the barrier layer and the biaxially stretched nylon film side of the base material layer were laminated, and then the laminate was subjected to an aging treatment to prepare a laminate having the biaxially stretched polyethylene terephthalate film/the adhesive/the biaxially stretched nylon film/the adhesive agent layer/the barrier layer.

Subsequently, maleic anhydride-modified polypropylene (thickness: 40 μm) as an adhesive layer and random polypropylene (thickness: 40 μm) as a heat-sealable resin layer were co-extruded onto the barrier layer of the laminate, such that the adhesive layer/the heat-sealable resin layer were laminated on the barrier layer. Subsequently, the resulting laminate was subjected to aging to obtain a battery packaging material in which the biaxially stretched polyethylene terephthalate film (12 μm)/the adhesive (3 μm)/the biaxially stretched nylon film (15 μm)/the adhesive agent layer (3 μm)/the barrier layer (40 μm) having acid resistance films (10 nm) on both surfaces/the maleic anhydride-modified polypropylene (40 μm)/the random polypropylene (40 μm) were laminated in this order.

### Example 3

Initially, a laminate having the biaxially stretched nylon film/the adhesive agent layer/the barrier layer having acid resistance films on both surfaces was prepared as in Example 1. Subsequently, to a surface of an acid resistance film of the laminate, an adhesive containing a non-crystalline polyolefin resin having a carboxyl group and a polyfunctional isocyanate compound (thickness after curing: 3 μm) was applied as an adhesive layer and dried. To the adhesive side of the laminate, an unstretched laminated polypropylene film (random polypropylene (thickness: 5 μm)/block polypropylene (thickness: 30 μm)/random polypropylene (thickness: 5 μm), total thickness: 40 μm) as a heat-sealable resin layer was laminated and bonded by being passed between two heated rolls, such that the adhesive layer/the heat-sealable resin layer were laminated on the barrier layer. Subsequently, the resulting laminate was subjected to aging to obtain a battery packaging material in which the biaxially stretched polyethylene terephthalate film (12 μm)/the adhesive (3 μm)/the biaxially stretched nylon film (15 μm)/the adhesive agent layer (3 μm)/the barrier layer (40 μm) having acid resistance films (10 nm) on both surfaces/the adhesive layer (3 μm)/the unstretched random polypropylene film (40 μm) were laminated in this order.

In Example 3, the acid resistance films on the surfaces of the barrier layer were formed as in Example 1, except that the amount of phosphoric acid was about 0.9 times (mass ratio) that in Example 1.

### Examples 4 and 5

In each of Examples 4 and 5, a battery packaging material was obtained as in Example 1, except that in the formation of the acid resistance films on the surfaces of the barrier layer in Example 4, the amount of phosphoric acid was about ½ times (mass ratio) that in Example 1, and in the formation of the acid resistance films on the surfaces of the barrier layer in Example 5, the amount of phosphoric acid was about 1.3 times (mass ratio) that in Example 1.

### Comparative Example 1

As a base material layer, a laminated film was prepared which was obtained by laminating polyethylene terephthalate and nylon by co-extrusion, and biaxially stretching the laminate. In the laminated film, the biaxially stretched polyethylene terephthalate film (thickness: 5 μm) and the biaxially stretched nylon film (thickness: 20 μm) were bonded with an adhesive agent layer (adhesive, thickness: 1 μm) composed of a resin composition containing a modified thermoplastic resin grafted with an unsaturated carboxylic acid derivative component. Subsequently, a barrier layer composed of aluminum foil (JIS H4160: 1994 A8021H-O, thickness: 40 μm), whose both surfaces had been subjected to a chemical conversion treatment using the below-described method to have acid resistance films (thickness: 10 nm) containing cerium thereon, was laminated to the biaxially stretched nylon film-side surface using the dry lamination method. Specifically, a two-liquid urethane adhesive (a polyol compound and an aromatic isocyanate-based compound) was applied to one surface of the aluminum foil having an acid resistance film to form an adhesive agent layer (thickness: 3 μm). Subsequently, the adhesive agent layer on the barrier layer having an acid resistance film and the biaxially stretched nylon film side of the base material layer were laminated, and then the laminate was subjected to an aging treatment to prepare a laminate having the biaxially stretched polyethylene terephthalate film/the adhesive/the biaxially stretched nylon film/the adhesive agent layer/the barrier layer having acid resistance films on both surfaces.

Subsequently, to a surface of an acid resistance film of the laminate, an adhesive containing a non-crystalline polyolefin resin having a carboxyl group and a polyfunctional isocyanate compound (thickness after curing: 3 μm) was applied as an adhesive layer and dried. To the adhesive side of the laminate, an unstretched laminated polypropylene film (random polypropylene (thickness: 5 μm)/block polypropylene (thickness: 30 μm)/random polypropylene (thickness: 5 μm), total thickness: 40 μm) as a heat-sealable resin layer was laminated and bonded by being passed between two heated rolls, such that the adhesive layer/the heat-sealable resin layer were laminated on the barrier layer. Subsequently, the resulting laminate was cured (aged) to obtain a battery packaging material in which the biaxially stretched polyethylene terephthalate film (5 μm)/the adhesive (1 μm)/the biaxially stretched nylon film (20 μm)/the adhesive agent layer (3 μm)/the barrier layer (40 μm) having acid resistance films (10 nm) on both surfaces/the adhesive layer (3 μm)/the unstretched laminated polypropylene film (40 μm) were laminated in this order.

In Comparative Example 1, the acid resistance films on the surfaces of the barrier layer were formed as follows: A treatment solution (containing water as the solvent and having a solids concentration of about 10% by mass) was prepared containing 20 parts by mass of an inorganic phosphorus compound (sodium phosphate salt) per 100 parts by mass of cerium oxide. The treatment solution was applied (film thickness after drying: 20 nm) to both surfaces of the barrier layer, and dried by heating for about 3 to 6 seconds at a temperature such that the surface temperature of the barrier layer became about 190 to 230° C.

### Comparative Example 2

A battery packaging material was obtained as in Comparative Example 1, except that an unstretched laminated polypropylene film (random polypropylene (thickness: 10 μm)/block polypropylene (thickness: 60 μm)/random polypropylene (thickness: 10 μm), total thickness: 80 μm) was used as a heat-sealable resin layer, instead of the unstretched laminated polypropylene film (thickness: 40 μm), to obtain the battery packaging material in which the biaxially stretched polyethylene terephthalate film (5 μm)/the adhesive (1 μm)/the biaxially stretched nylon film (20 μm)/the adhesive agent layer (3 μm)/the barrier layer (40 μm) having acid resistance films (10 nm) on both surfaces/the adhesive layer (3 μm)/the unstretched laminated polypropylene film (80 μm) were laminated in this order. As the aluminum foil used as the barrier layer, aluminum foil having the same acid resistance films as those in Comparative Example 1 was used.

### Comparative Examples 3 and 4

In each of Comparative Examples 3 and 4, a battery packaging material was obtained as in Example 1, except that in the formation of the acid resistance films on the surfaces of the barrier layer in Comparative Example 3, the amount of phosphoric acid was about ⅓ times (mass ratio) that in Example 1, and in the formation of the acid resistance films on the surfaces of the barrier layer in Comparative Example 4, the amount of phosphoric acid was about 1.5 times (mass ratio) that in Example 1.

<Time-of-Flight Secondary Ion Mass Spectrometry>

The analysis of the acid resistance films was performed as follows: Initially, the barrier layer and the adhesive layer were peeled apart. At this time, the barrier layer and the adhesive layer were physically peeled apart without using water or an aqueous solution of an organic solvent, an acid, or an alkali. Because the adhesive layer remained on the surface of the barrier layer after peeling between the barrier layer and the adhesive layer, the remaining adhesive layer was removed by etching with Ar-GCIB. The acid resistance film on the thus-obtained surface of the barrier layer was analyzed using time-of-flight secondary ion mass spectrometry. Table 1 shows, for each example, peak intensity P_{CrPO4} derived from CrPO₄⁻, peak intensity P_{PO2} derived from PO₂⁻, and peak intensity P_{PO3} derived from PO₃⁻; and the P_{PO2/CrPO4} ratio, which is the ratio of peak intensity P_{PO2} to peak intensity P_{CrPO4}, and the P_{PO3/CrPO4} ratio, which is the ratio of peak intensity P_{PO3} to peak intensity P_{CrPO4}. In Comparative Examples 1 and 2, cerium instead of chromium was used in the treatment solution for the chemical conversion treatment; therefore, the items concerning peak intensity P_{CrPO4} derived from CrPO₄⁻ are denoted as “-”.

The details of the measurement apparatus and conditions for time-of-flight secondary ion mass spectrometry are as follows:

Measurement apparatus: time-of-flight secondary ion mass spectrometer TOF.SIMS5 manufactured by ION-TOF GmbH.

(Measurement Conditions)

Primary ion: doubly charged ion of bismuth cluster (Bi₃⁺⁺)

Primary ion acceleration voltage: 30 kV

Mass range (m/z): 0-1500

Measurement range: 100 μm×100 μm

Number of scans: 16 scans/cycle

Number of pixels (per side): 256 pixels

Etching ion: Ar gas cluster ion beam (Ar-GCIB)

Etching ion acceleration voltage: 5.0 kV

<Evaluation of Adhesion>

The adhesion between the barrier layer and the heat-sealable resin layer when an electrolytic solution adheres to the battery packaging material was evaluated by measuring the peeling strength (N/15 mm), using the following method.

Initially, each of the battery packaging materials obtained above was cut into a size of 15 mm (TD: Transverse Direction; lateral direction)×100 mm (MD: Machine Direction; longitudinal direction) to provide a specimen. In a glass bottle, the specimen was placed, followed by an electrolytic solution (lithium hexafluorophosphate (concentration in the solution: 1×10³ mol/m³) in a solution obtained by mixing ethylene carbonate, diethyl carbonate, and dimethyl carbonate at a volume ratio of 1:1:1), and the entire specimen was immersed in the electrolytic solution. In this state, the glass bottle was sealed with a cap. The sealed glass bottle was placed in an oven set at 85° C., and allowed to stand for 24 hours. Subsequently, the glass bottle was removed from the oven, the specimen was then removed from the glass bottle and washed with water, and the moisture on the surface of the specimen was wiped off with a towel.

Subsequently, the heat-sealable resin layer and the barrier layer of the specimen were peeled apart, and, using a tensile testing machine (trade name AGS-XPlus manufactured by Shimadzu Corporation), the heat-sealable resin layer side and the barrier layer side of the specimen were pulled in the 180° direction at a gauge length of 50 mm and a rate of 50 mm/minute, and the peeling strength (N/15 mm) of the specimen was measured. The measurement of the peeling strength of the specimen was performed within 10 minutes after wiping off the moisture on the surface of the specimen with a towel. The strength when the gauge length had reached 57 mm was determined as the peeling strength of the specimen.

On the other hand, the initial adhesion was evaluated as follows: Initially, each of the battery packaging materials obtained in Examples 1 to 5 and Comparative Examples 1 and 2 was cut into a size of 15 mm (TD)×100 mm (MD) to provide a specimen. Subsequently, the heat-sealable resin layer and the barrier layer of the specimen were peeled apart, and, using a tensile testing machine (trade name AGS-XPlus manufactured by Shimadzu Corporation), the heat-sealable resin layer and the barrier layer were pulled in the 180° direction at a gauge length of 50 mm and a rate of 50 mm/minute, and the peeling strength (N/15 mm) of the specimen was measured as the initial adhesion. The results are shown in Table 1. Table 1 also shows the retention ratio of the peeling strength as the adhesion after the immersion in the electrolytic solution, relative to the peeling strength as the initial adhesion taken as 100%, and the peeling strength after immersion in the electrolytic solution (after 24, 72, or 168 hr). It should be noted that when the heat-sealable resin layer and the barrier layer were peeled apart, the adhesive layer positioned between these layers was laminated on either one of or both the heat-sealable resin layer and the barrier layer.

TABLE 1

| | | | | | | | Adhesion after Immersion in | | |
|---|---|---|---|---|---|---|---|---|---|
| | | | | | | | Electrolytic Solution 85° C., | | |
| | | | | | | | 24 hr, 72 hr, 168 hr | | |
| | | | | | | Initial | Peeling Strength (N/15 mm) | | |
| | | | | | | Adhesion | (Retention Ratio of Peeling | | |
| | Time-of-Flight Secondary Ion Mass Spectrometry | | | | | Peeling | Strength to Initial Peeling | | |
| | Peak Intensity | | | Peak Intensity Ratio | | Strength | Strength) | | |
| | P_{PO2} | P_{PO3} | P_{PO4} | P_{PO2}/P_{CrPO4} | P_{PO3}/P_{CrPO4} | (N/15 mm) | 24 hr | 72 hr | 168 hr |
| Example 1 | 2.2 × 10⁵ | 3.7 × 10⁵ | 1.2 × 10⁴ | 18.3 | 30.8 | 10.7 | 9.9 | 9.6 | 9.1 |
| | | | | | | | (93%) | (90%) | (85%) |
| Example 2 | 2.2 × 10⁵ | 3.7 × 10⁵ | 1.2 × 10⁴ | 18.3 | 30.8 | 15.7 | 12.8 | 11.4 | 11.2 |
| | | | | | | | (82%) | (73%) | (72%) |
| Example 3 | 6.3 × 10⁵ | 1.0 × 10⁵ | 3.8 × 10⁴ | 16.6 | 26.3 | 14.0 | 13.0 | 10.1 | 9.4 |
| | | | | | | | (93%) | (72%) | (67%) |
| Example 4 | 8.2 × 10⁴ | 6.7 × 10⁴ | 1.0 × 10⁴ | 8.2 | 6.7 | 9.6 | 9.3 | 8.4 | 7.3 |
| | | | | | | | (97%) | (88%) | (76%) |
| Example 5 | 4.2 × 10⁵ | 6.9 × 10⁵ | 6.6 × 10³ | 63.6 | 104.5 | 13.6 | 11.0 | 9.7 | 8.8 |
| | | | | | | | (81%) | (71%) | (65%) |
| Comparative | 4.0 × 10⁵ | 3.3 × 10⁵ | 3.5 × 10³ | — | — | 14.9 | 10.3 | 9.4 | 4.0 |
| Example 1 | | | | | | | (69%) | (63%) | (27%) |
| Comparative | 4.0 × 10⁵ | 3.3 × 10⁵ | 3.5 × 10³ | — | — | 22.3 | 13.6 | 12.4 | 8.5 |
| Example 2 | | | | | | | (61%) | (56%) | (38%) |
| Comparative | 6.7 × 10⁵ | 5.9 × 10⁵ | 1.0 × 10⁵ | 6.7 | 5.9 | 7.3 | 0.8 | 0 | 0 |
| Example 3 | | | | | | | (11%) | (0%) | (0%) |
| Comparative | 8.2 × 10⁵ | 1.3 × 10⁶ | 8.2 × 10³ | 100.0 | 158.5 | 13.4 | 8.3 | 7.1 | 4.2 |
| Example 4 | | | | | | | (62%) | (53%) | (31%) |

As is clear from the results shown in Table 1, it is observed that each of the battery packaging materials according to Examples 1 to 5, comprising an acid resistance film on a surface of the barrier layer, wherein when the acid resistance film is analyzed using time-of-flight secondary ion mass spectrometry, the P_{PO3/CrPO4} ratio, which is the ratio of peak intensity P_{PO3} derived from PO₃⁻ to peak intensity P_{CrPO4} derived from CrPO₄⁻, falls within the range of 6 to 120, has excellent adhesion between the barrier layer and the heat-sealable resin layer over a long period, after the immersion in the electrolytic solution, even though it comprises the acid resistance film on the surface of the barrier layer. Moreover, in each of the battery packaging materials according to Examples 1 to 5, the P_{PO2/CrPO4} ratio, which is the ratio of peak intensity P_{PO2} derived from PO₂⁻ to peak intensity P_{CrPO4} derived from CrPO₄⁻, falls within the range of 7 to 70, and these battery packaging materials have excellent adhesion between the barrier layer and the heat-sealable resin layer over a long period.

### REFERENCE SIGNS LIST

1: base material layer
2: adhesive agent layer
3: barrier layer
3a, 3b: acid resistance film
4: heat-sealable resin layer
5: adhesive layer
6: surface coating layer
10: battery packaging material

1. A battery packaging material comprising:
a laminate comprising at least a base material layer, a barrier layer, and a heat-sealable resin layer in this order,
wherein the battery packaging material comprises an acid resistance film on at least one surface of the barrier layer, and
when the acid resistance film is analyzed using time-of-flight secondary ion mass spectrometry, a P_{PO3/CrPO4} ratio, which is the ratio of peak intensity P_{PO3} derived from PO₃⁻ to peak intensity P_{CrPO4} derived from CrPO₄⁻, falls within a range of 6 to 120.

2. The battery packaging material according to claim 1, wherein the battery packaging material comprises the acid resistance film on at least a surface of the barrier layer facing the heat-sealable resin layer.

3. The battery packaging material according to claim 2, wherein the acid resistance film and the heat-sealable resin layer are laminated with an adhesive layer interposed therebetween.

4. The battery packaging material according to claim 3, wherein a resin constituting the adhesive layer has a polyolefin backbone.

5. The battery packaging material according to claim 3, wherein the adhesive layer contains an acid-modified polyolefin.

6. The battery packaging material according to claim 3, wherein when the adhesive layer is analyzed using infrared spectroscopy, a peak derived from maleic anhydride is detected.

7. The battery packaging material according to claim 6, wherein the acid-modified polyolefin in the adhesive layer is maleic anhydride-modified polypropylene, and
the heat-sealable resin layer contains polypropylene.

8. The battery packaging material according to claim 3, wherein the adhesive layer is a cured product of a resin composition containing at least one selected from the group consisting of a compound having an isocyanate group, a compound having an oxazoline group, and a compound having an epoxy group.

9. The battery packaging material according to claim 3, wherein the adhesive layer is a cured product of a resin composition containing a curing agent having at least one selected from the group consisting of an oxygen atom, a heterocyclic ring, a C═N bond, and a C—O—C bond.

10. The battery packaging material according to claim 3, wherein the adhesive layer contains at least one selected from the group consisting of a urethane resin, an ester resin, and an epoxy resin.

11. The battery packaging material according to claim 1, wherein the barrier layer is composed of aluminum foil.

12. The battery packaging material according to claim 1, wherein a resin constituting the heat-sealable resin layer contains a polyolefin backbone.

13. A method for producing a battery packaging material comprising the step of:
obtaining a laminate by laminating at least a base material layer, a barrier layer, and a heat-sealable resin layer in this order,
wherein when the barrier layer is laminated, the barrier layer comprises an acid resistance film on at least one surface thereof, and when the acid resistance film is analyzed using time-of-flight secondary ion mass spectrometry, a P_{PO3/CrPO4} ratio, which is the ratio of peak intensity P_{PO3} derived from PO₃⁻ to peak intensity P_{CrPO4} derived from CrPO₄⁻, falls within a range of 6 to 120.

14. A battery comprising a battery element comprising at least a positive electrode, a negative electrode, and an electrolyte, the battery element being housed in a package formed of the battery packaging material according to claim 1.

15. The battery packaging material according to claim 1, wherein the base material layer comprises at least one selected from the group consisting of polyester and polyamide.

16. The battery packaging material according to claim 1, wherein the thickness of the base material layer is about 3 to 50 μm.

17. The battery packaging material according to claim 1, wherein the thickness of the base material layer is about 10 to 35 μm.

18. A battery packaging material comprising:
a laminate comprising at least a base material layer, a barrier layer, and a heat-sealable resin layer in this order,
wherein:
the base material layer is formed of a single layer of a polyester film, or the base material layer has a two layer structure of a polyester film and a nylon film, or the base material layer has a two layer structure of nylon films,
the battery packaging material comprises an acid resistance film on at least one surface of the barrier layer, and
when the acid resistance film is analyzed using time-of-flight secondary ion mass spectrometry, a P_{PO3/CrPO4} ratio, which is the ratio of peak intensity P_{PO3} derived from PO₃⁻ to peak intensity P_{CrPO4} derived from CrPO₄⁻, falls within a range of 6 to 120.
